(19) United States
(12) Patent Application Publication
(10) Pub. No.: US 2024/0276238 A1
(43) Pub. Date: Aug. 15, 2024

(54) AGILE BEAM TRACKING

(71) Applicant: Huawei Technologies Co., Ltd., Shenzhen (CN)

(72) Inventors: Jalal Khamse Ashari, Stittsville (CA); Amine Maaref, Ottawa (CA)

(21) Appl. No.: 18/645,252

(22) Filed: Apr. 24, 2024

Related U.S. Application Data
(63) Continuation of application No. PCT/CN2021/127624, filed on Oct. 29, 2021.

(51) Int. Cl. H04W 16/28; H04W 64/00; H04W 76/20

(52) U.S. Cl. CPC H04W 16/28; H04W 64/00; H04W 76/20

(57) ABSTRACT

Some embodiments of the present disclosure provide for signaling, by a transmit receive point, of information that allows a user equipment to perform a beam tracking procedure. The information may indicate a shift of direction for a transmit beam with respect to a reference beam direction. In addition to signaling a shift of direction for a transmit beam, aspects of the present application relate to a method of detecting, at the user equipment, beam misalignments. The beam misalignments may be detected in the absence of an estimate of location of the user equipment, in the absence of an estimate of location of the transmit/receive point and in the absence of an estimate of a mobility pattern. Aspects of the present application also relate to a method of using a transmit/receive beam pair direction of one transmit receive point for beam establishment and beam tracking for a second transmit receive point.

### CROSS-REFERENCE TO RELATED APPLICATIONS

This application is a continuation of International Application No. PCT/CN2021/127624, filed on Oct. 29, 2021, which is hereby incorporated by reference in its entirety.

### TECHNICAL FIELD

The present disclosure relates, generally, to beam management for wireless communication and, in particular embodiments, to agile beam tracking.

### BACKGROUND

In the current standard for fifth generation wireless communication (5G) new radio (NR), established by 3rd Generation Partnership Project (3GPP), a “beam sweeping” mechanism is executed to determine a best transmit-receive beam pair for each User Equipment (UE). The beam sweeping mechanism relies upon Synchronization Signal Blocks (SSBs), which are transmitted, by a transmit and receive point (TRP), in different directions using different transmit (Tx) beams. Consequently, the SSBs are received, by the UE, from different directions. In an initial access procedure, the UE evaluates a received signal power of each received SSB to identify best transmit-receive beam directions. These beam directions may be referenced as a best transmit/receive (Tx/Rx) beam pair.

After the initial access procedure, a beam refinement/tracking procedure is known to be repeatedly executed. The beam tracking procedure allows each UE to refine the alignment of Tx and Rx beams to cope with the changes in relative position between the UE and the TRP with which the UE is communicating. To assist the UE in carrying out the beam tracking procedure, the TRP may repeatedly transmit, to the UE, UE-specific channel state information reference signals (CSI-RSs). The CSI-RSs may have a beam-width that is narrower than the beam-width of the SSBs. Reception and measurement, at the UE, of reference signals may allow the UE to detect a failure on a particular beam pair. Such a beam failure may be remedied by the UE restarting, from scratch, the beam sweeping procedure. The beam sweeping procedures may be considered to impose a considerable overhead on both the UE and the TRP, especially when the TRP is in motion. One case of a TRP in motion is an aerial, or “non-terrestrial,” TRP.

### SUMMARY

Aspects of the present application relate to signaling, by a transmit receive point, of information that allows a user equipment to perform an agile beam tracking procedure. The information may indicate a shift of direction for a transmit beam with respect to a reference beam direction. In addition to signaling a shift of direction for a transmit beam, aspects of the present application relate to a method of detecting, at the user equipment, beam misalignments. Conveniently, the beam misalignments may be detected in the absence of an estimate of location of the user equipment, in the absence of an estimate of location of the transmit receive point and in the absence of an estimate of a mobility pattern. Aspects of the present application also relate to a method of exploiting a transmit/receive beam pair direction of one transmit receive point to facilitate beam establishment and beam tracking for a second transmit receive point.

The use of directional beams in modern communication is associated with various issues, including a beam failure rate that is too high, a beam switching rate that is too high, a beam alignment that is too coarse and too much signaling and overhead for beam establishment, refinement and tracking.

Aspects of the present application may be shown to reduce beam failure rates by exploiting knowledge of a beam angular direction adjustment to, thereby, detect an impending beam misalignment before a beam failure occurs. Aspects of the present application may also be shown to reduce beam switching rates by introducing mechanisms by which a beam direction may be gradually shifted. Aspects of the present application may also be shown to enhance beam alignment in the absence of an accurate estimate of the communicating devices. The beam alignment may be enhanced by enabling receiving devices to detect misalignments in advance and, responsively, to transmit feedback to a transmitting device so that the transmitting device may adjust a transmit beam. Aspects of the present application may also be shown to reduce signaling and overhead for beam establishment, refinement and tracking. In case of one of more than one transmitting device, transmission of receiving-device-specific reference signals need not be carried out when beam directions of established beams associated with other transmitting devices are known.

According to an aspect of the present disclosure, there is provided a method of beam tracking at a first device. The method includes determining a first transmit beam direction, transmitting a first transmission to a second device, the first transmission using the first transmit beam direction. The method further includes determining a second transmit beam direction based on the first transmit beam direction and a beam angular direction adjustment. The method also includes transmitting a second transmission, subsequent to the first transmission, from the first device to the second device, the second transmission using the second transmit beam direction, wherein the beam angular direction adjustment refers to changes, over a time interval, in transmit beam directions.

According to an aspect of the present disclosure, there is provided a method of beam tracking at a first device. The method includes receiving communication from a second device, the receiving using a first receive beam direction, receiving, from the second device, an indication of a beam angular direction adjustment for the communication, wherein the beam angular direction adjustment refers to changes, over a time interval, in transmit beam directions, detecting, based on the beam angular direction adjustment, a beam misalignment, shifting the first receive beam direction according to the beam angular direction adjustment to, thereby, obtain a second receive beam direction and receiving communication from the second device, the receiving using the second receive beam direction.

According to an aspect of the present disclosure, there is provided a method, carried out at a first device, of facilitating beam tracking. The method includes receiving communication from a second device, the receiving the communication using a second receive beam direction, receiving a reference signal from a third device, the receiving the reference signal using a third receive beam direction, determining a receive beam direction difference between the second receive beam direction and the third receive beam direction and transmitting, to the third device, an indication of the receive beam direction difference, thereby facilitating beam tracking at the third device.

According to an aspect of the present disclosure, there is provided a method, carried out at a first device, of facilitating beam tracking at a second device. The method includes receiving a plurality of tracking reference signals, each tracking reference signal of the plurality of tracking reference signals associated with a beam direction and a distinct time of receipt, obtaining measurements of the plurality of tracking reference signals, processing the measurements to, thereby, obtain a pace of changes in a preferred receive beam direction, determining, based on the pace of changes, an adjustment to be made to a transmit beam direction at the second device and transmitting, to the second device, an indication of the adjustment.

According to an aspect of the present disclosure, there is provided a method to be carried out at a first device. The method includes measuring a first transmit beam direction towards a second device relative to a predetermined horizontal coordinate system, receiving, from a third device, a second transmit beam direction towards the second device relative to the predetermined horizontal coordinate system, determining a beam direction difference between the first transmit beam direction and the second transmit beam direction and transmitting, to the second device, an indication of the beam direction difference, thereby allowing the second device to obtain a receive beam direction for communication with the third device.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates example steps in a method of facilitating agile beam tracking, in accordance with aspects of the present application;

FIG. 7 illustrates example steps in a method of feeding back beam tracking information, in accordance with aspects of the present application;

FIG. 8 illustrates a portion of a network, the portion including two non-terrestrial transmit receive points and a user equipment;

FIG. 9 illustrates, in a signal flow diagram, a method of transferring information to, thereby, allow for determination of a receive beam direction, in accordance with aspects of the present application;

FIG. 10A illustrates a histogram showing measured tracking reference signal received power values on a vertical axis and tracking reference signal beam directions on a horizontal axis, in accordance with aspects of the present application;

FIG. 10B illustrates a histogram showing filtered tracking reference signal received power values on a vertical axis and tracking reference signal beam directions on a horizontal axis, in accordance with aspects of the present application; and

FIG. 11 illustrates example steps in a method of using tracking reference signals, received at a user equipment, to facilitate agile beam tracking at a non-terrestrial transmit receive point, in accordance with aspects of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

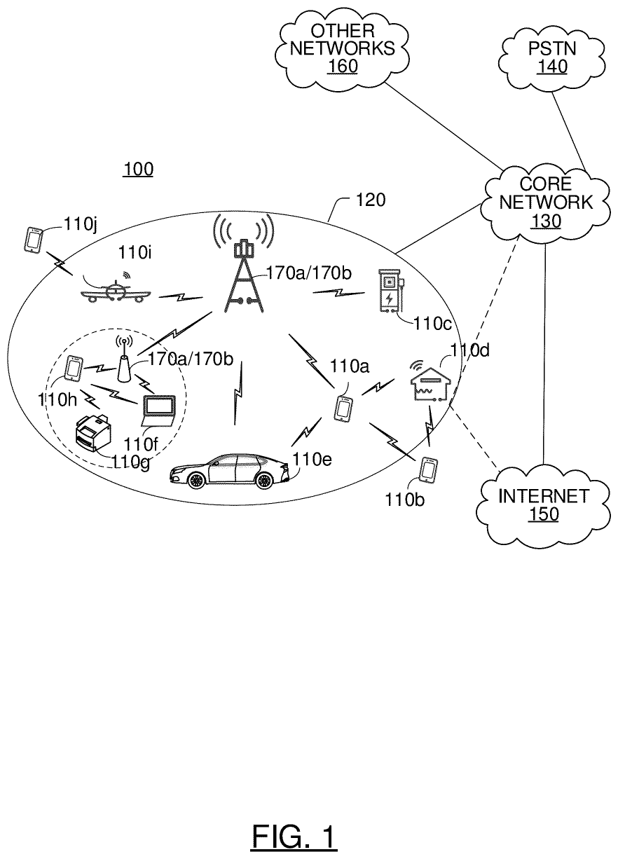

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

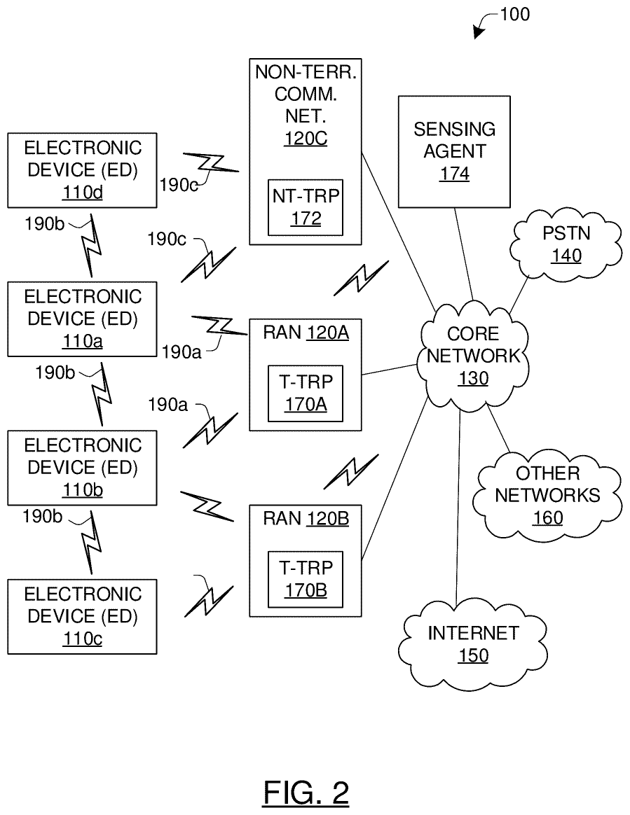

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, nod (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs roa, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

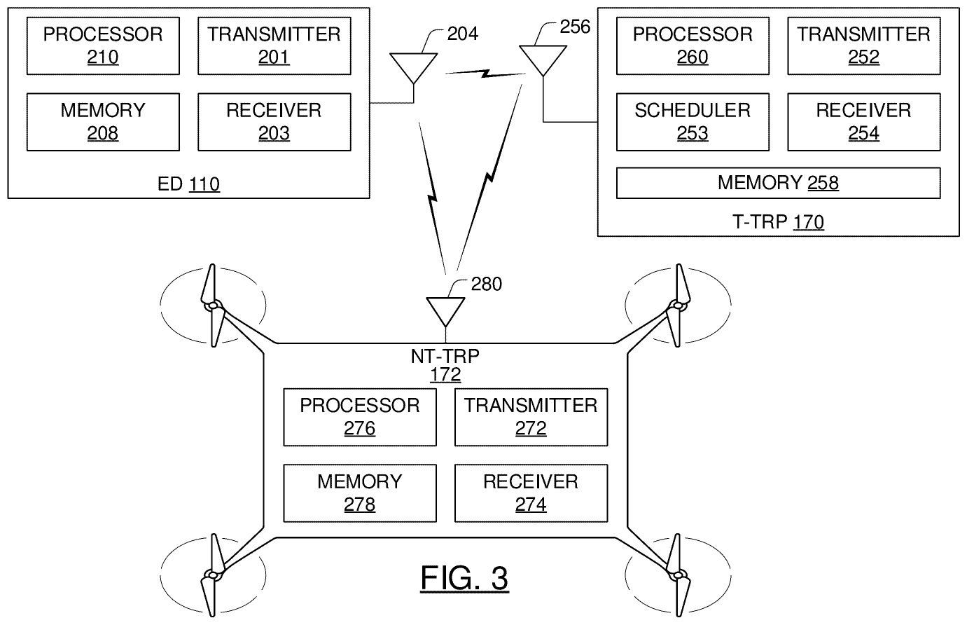

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data.

Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

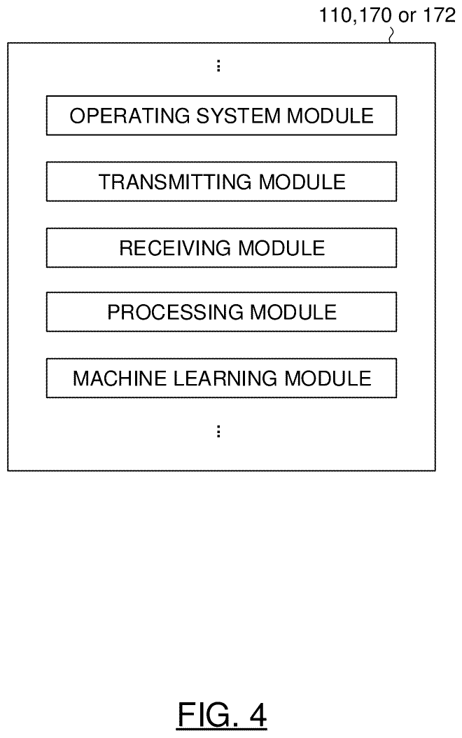

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and a UE. The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0-5%.

The carrier, the BWP or the occupied bandwidth may be signaled by a network device (e.g., by a base station 170) dynamically, e.g., in physical layer control signaling such as the known downlink control information (DCI) channel, or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). Although the sensing system can be separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

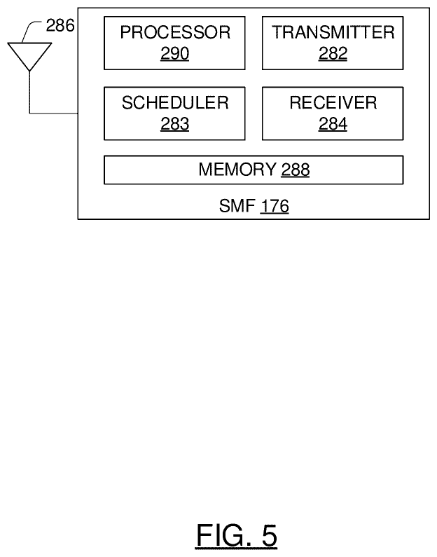

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in the process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel to be reconstructed with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, and a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. It can be challenging to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO), thereby substantially reducing the costs for launching satellites to lower orbits. The non-terrestrial communication system may be a communications system using high altitude platforms (HAPs), which are known to provide a low path-loss air interface for the UEs with limited power budget. The non-terrestrial communication system may be a communications system using Unmanned Aerial Vehicles (UAVs) (or unmanned aerial system, “UAS”) achieving a dense deployment, because their coverage can be limited to a local area, such as airborne, balloon, quadcopter, drones, etc. In some examples, a network formed of GEO satellites, LEO satellites, UAVs, HAPs or VLEOs may be deployed all at the same altitude, thereby providing a network that may be considered two-dimensional. In some other examples, UAVs, HAPs and VLEOs may be coupled to integrate satellite communications to cellular networks. Emerging three-dimensional vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO wireless communication system with the T-TRP 170 and/or the NT-TRP 172 configured with a large number of antennas (sometimes called large-scale MIMO) has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each UE to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and UEs and the effect of noise can be reduced.

A MIMO system may include a receiver connected to a receive (Rx) antenna array, a transmitter connected to transmit (Tx) antenna array, and a signal processor connected to the transmitter and the receiver. Each of the Rx antenna array and the Tx antenna array may include a plurality of antennas. For instance, the Rx antenna array may be a uniform linear array (ULA) antenna, in which the plurality of antennas are arranged in line at even intervals. When a radio frequency (RF) signal is transmitted through the Tx antenna array, the Rx antenna array may receive a signal reflected and returned from a forward target.

Aspects of a MIMO system that may be configured include: panels; and beams.

A panel is a unit of an antenna group, or antenna array, or antenna sub-array, which unit can control a Tx beam or an Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or an Rx beam. The transmit beam indicates distribution of signal strength formed in different directions in space after a signal is transmitted through an antenna. The receive beam indicates distribution of signal strength of a wireless signal received from an antenna in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

It is known that a beam misalignment can lead to a beam failure. In a scenario with a fixed-position T-TRP 170 and a stationary UE 110, beam misalignment is unlikely. However, beam misalignment is expected in a scenario with a fixed-position T-TRP 170 and a mobile UE 110, in a scenario with an NT-TRP 172 and a stationary UE 110 and in a scenario with an NT-TRP 172 and a mobile UE 110. The transmit/receive beam direction may be subject to repetitive refinement, though use of a beam tracking procedure, when the UE 110 is stationary and the NT-TRP 172 is in motion.

One challenge for the beam tracking procedure is a difficulty in achieving, at the NT-TRP 172, an accurate estimate of the mobility of the UE 110, while the NT-TRP 172 is also subject to unpredictable movements, e.g., due to air turbulence in the environment of the NT-TRP 172. In recognition of limited power or processing capabilities at the NT-TRP 172, it is suggested, herein, that any algorithm executed at the NT-TRP 172 to assist in a beam tracking procedure, at the UE 110, should have a low complexity.

In overview, aspects of the present application relate to signaling, by a transmitter, such as the NT-TRP 172, information that allows a receiver, such as the UE 110, to perform an agile beam tracking procedure. The transmitter may also perform an agile beam tracking procedure to, thereby, maintain alignment for both the receiver and transmitter beams. Further to the goal of maintaining alignment, the transmitter may receive feedback from the receiver and, based on the feedback, fine tune the beam tracking procedure. The information may indicate a shift of direction for a transmit beam with respect to a reference beam direction. In addition to signaling a shift of direction for a transmit beam, aspects of the present application relate to a method of detecting, at the UE 110, beam misalignments. Conveniently, the beam misalignments may be detected even in the absence of an estimate of location of the UE 110, in the absence of an estimate of location of the NT-TRP 172 and in the absence of an estimate of a mobility pattern. Aspects of the present application also relate to a method of exploiting a transmit/receive beam pair direction of one TRP to facilitate beam establishment and beam tracking for a second TRP. Conveniently, aspects of the present application may be shown to reduce signaling overhead. Furthermore, the UE 110 and/or the NT-TRP 172 need not know their own location. Indeed, it should be clear that aspects of the present application are generally applicable to communication between any two nodes that are moving relative to each other.

In aspects of the present application, both the UE 110 and the TR-TRP 172 are configured to shift respective receive/transmit beam directions so as to compensate for the mobility of the UE 110 and/or the mobility of the NT-TRP 172. A beam angular direction adjustment is defined. The beam angular direction adjustment refers to changes in beam direction, in two orthogonal base directions, with respect to a reference beam over a time interval. The NT-TRP 172 maintains a configured beam angular direction adjustment for each beam with respect to a coordinate system centered at the location of the NT-TRP 172. The beam angular direction adjustment may be configured to, for example, compensate for angular rotations of the NT-TRP 172. According to aspects of the present application, the beam angular direction adjustment may be indicated, to the UE 110, using a combination of RRC signaling and dynamic indication. In particular, the RRC signaling may be used to indicate beam shifting direction, beam shifting velocity and an association to a Transmission Configuration Indicator (TCI) state. Further particularly, the dynamic indication may use the DCI channel or a MAC control element (MAC-CE).

Receipt, from the NT-TRP 172, of a transmit beam angular direction adjustment may prompt the UE 110 to adjust a receive beam direction. The UE 110 may further use the indicated transmit beam angular direction adjustment to determine an initial indicated receive beam direction. The UE 110 may then use local measurements to refine the adjusted receive beam direction until a more accurate adjusted receive beam direction, an “actual receive beam direction,” is found. If the actual receive beam direction is found to deviate from the initial indicated receive beam direction by more than a certain threshold, a beam tracking feedback procedure may be triggered. As part of the beam tracking feedback procedure, the UE 110 may indicate, to the NT-TRP 172, a change to implement in the transmit beam direction to, thereby, correspond to an impending change in the receive beam direction. In other aspects of the present application, the proposed signaling method may exploit the transmit/receive beam pair direction established with one TRP to facilitate beam establishment and tracking for a second TRP.

Aspects of the present application relate to use of a “beam angular direction adjustment” that may be defined for each beam-based transmitted signal. Starting at an initial transmit beam direction, the transmitter may gradually shift, in accordance with the defined beam angular direction adjustment, the transmit beam direction. Similarly, the receiver may start with an initial receive beam direction and gradually shift the receive beam direction in accordance with the defined beam angular direction adjustment. The beam angular direction adjustment may be defined in a manner that includes compensation for the mobility of the UE 110 and/or the mobility of the NT-TRP 172.

This gradual shifting stands in contrast to the method of the current NR standard, where the transmitter and receiver keep using the same beam direction until another round of measurements, based on beam sweeping, is carried out. Indeed, on the basis of such measurements, the transmitter and/or the receiver may determine that it would be beneficial to switch to a new beam direction. It may be shown that the method of the current NR standard may allow a beam failure to occur before the transmit/receive beam pair is switched to a new direction.

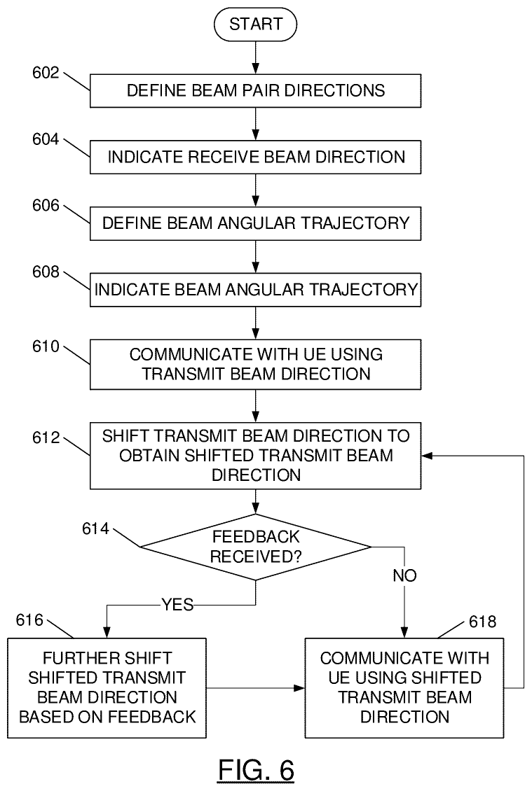

FIG. 6 illustrates example steps in a method of facilitating agile beam tracking at the NT-TRP 172. The method may begin with the NT-TRP 172 defining (step 602) a direction for a transmit/receive beam pair to be used for communicating with a given UE 110. The transmit/receive beam pair includes a transmit beam with a transmit beam direction and a corresponding receive beam with a receive beam direction. The NT-TRP 172 may also define a reference beam. In particular, the reference beam may be defined to have the same direction as the transmit/receive beam pair associated with the given UE 110. That is, the transmit/receive beam pair is Quasi Co-Located (QCL) with the reference beam.

Subsequent to defining the initial directions for the beam pair, the NT-TRP 172 may indicate (step 604), to the UE 110, the receive beam direction. Upon receipt of the indicated receive beam direction, the UE 110 may use the indicated receive beam direction as the initial receive beam direction in which to expect receipt of communication from the NT-TRP 172. The UE 110 and the NT-TRP 172 may then proceed to communicate.

The NT-TRP 172 may then define (step 606) an appropriate beam angular direction adjustment. The beam angular direction adjustment may be defined (step 606) to refer to a rate of change of the transmit beam direction with respect to the reference beam direction. The beam angular direction adjustment may be defined (step 606) in relation to a fixed coordinate system centered at the location of the NT-TRP 172. The beam angular direction adjustment may be defined (step 606) to compensate for angular rotations of the NT-TRP 172. The beam angular direction adjustment may be defined (step 606) to refer to a pace and a direction of future shifts in the transmit beam direction. The beam angular direction adjustment may be defined (step 606) by making a selection from among a plurality of candidate beam angular direction adjustments. Each of the candidate beam angular direction adjustments may be associated with an index. The NT-TRP 172 may receive, from the UE 110 or another NT-TRP 172, an indication of the index. The NT-TRP 172 may then define (step 606) the beam angular direction adjustment by selecting the candidate beam angular direction adjustment that is associated with the received index.

Subsequent to the defining (step 606) of the beam angular direction adjustment, the NT-TRP 172 may indicate (step 608), to the given UE 110, the beam angular direction adjustment. Accordingly, the UE 110 may use the beam angular direction adjustment to manage a pace and a direction of future shifts in the receive beam direction. Notably, the indicating (step 608), to the given UE 110, of the beam angular direction adjustment may be accomplished in two stages. In a first stage, the NT-TRP 172 may configure the given UE 110 with one or more possible beam direction adjustments. In some aspects of the present application, wherein a plurality of beam direction adjustments are configured, each beam direction adjustment is associated with a distinct TCI state. In a second stage, the NT-TRP 172 may simply indicate the TCJ state that is to be used for transmission. At the given UE 110, the indication of the TCJ state may be used to select the one beam direction adjustment, among the plurality of beam direction adjustments, that is associated with the indicated TC state.

The NT-TRP 172 may proceed to communicate (step 610) with the UE 110 using the transmit beam direction defined in step 602. The NT-TRP 172 may then shift (step 612) the transmit beam direction according to the pace and the direction referred to in the beam angular direction adjustment to, thereby, obtain a shifted transmit beam direction. Similarly, the UE 110 may shift the receive beam direction according to the pace and the direction referred to in the beam angular direction adjustment to, thereby, obtain a shifted receive beam direction. It has been suggested, hereinbefore, that, as part of a beam tracking feedback procedure, the UE 110 may indicate, to the NT-TRP 172, a change to implement in the transmit beam direction. Such a change would correspond to an impending change in the receive beam direction. Accordingly, the NT-TRP 172 may determine (step 614) whether beam tracking feedback has been received from the UE 110. Upon determining (step 614) that beam tracking feedback has been received from the UE 110, the NT-TRP 172 may update (step 616) the transmit beam direction based on the feedback from the UE. The NT-TRP 172 may then continue to communicate (step 618) with the UE 110 using the shifted transmit beam direction obtained in step 616. Upon determining (step 614) that beam tracking feedback has not been received from the UE 110, the NT-TRP 172 may continue to communicate (step 618) with the UE 110 using the shifted transmit beam direction obtained in step 612.

In general, the beam angular direction adjustment can be defined (step 606) in terms of a respective transition in two orthogonal directions (such as an azimuth direction and an elevation direction) in a three-dimensional beamforming platform. An angular velocity may be referred to in terms of steps of a particular magnitude that the transmit beam is to be shifted in each orthogonal direction during a time interval. The shifting (step 612) of the transmit beam direction may be carried out as a repeated change over a series of time intervals, thereby indicating a direction adjustment. Alternatively, the shifting (step 612) of the transmit beam direction may be carried out as a one-time shift to the transmit beam direction. It follows that the NT-TRP 172 is to indicate, to the UE 110, whether the shifting (step 612) of the transmit beam direction is part of an ongoing direction adjustment or is a one-time shift.

Different methods can be used to define (step 606) the beam angular direction adjustment at the NT-TRP 172.

In one method, the NT-TRP 172 may have a rough estimate of a moving direction for the UE 110. The rough estimate may be based on a context, such as a highway scenario. The rough estimate may be based on measurements, made by the NT-TRP 172, of uplink reference signals transmitted by the UE 110. The NT-TRP 172 then define (step 606) the beam angular direction adjustment based on the rough estimate of the moving direction for the UE 110.

In another method, both the NT-TRP 172 and the UE 110 may have access to a plurality of possible beam angular direction adjustment configurations. The UE 110 then may select one of the beam angular direction adjustment configurations based on information about mobility of the UE 110. The UE 110 may then provide, to the NT-TRP 172, an indication of the selected beam angular direction adjustment configuration. Accordingly, defining (step 606) the beam angular direction adjustment may relate to receiving, from the UE 110, the indication of the selected beam angular direction adjustment configuration.

When indicating (step 608) the beam angular direction adjustment, the NT-TRP 172 may further indicate a time interval in addition to a beam shift in each of the orthogonal directions. Because the beam shifting is indicated with respect to a reference direction, only a few bits may be used to indicate the changes in each of the orthogonal beam directions. For example, four bits may be understood as sufficient to indicate a beam shift of 1° to 16°, inclusive, with a granularity of 1°.

The indicating (step 608) of the beam angular direction adjustment may use signaling based on a combination of RRC signaling and dynamic indication. The RRC signaling may be used, e.g., to configure the possible beam shifting directions/velocities as well as to configure the association to the TCI states. The dynamic indication may accomplished, e.g., using a DCI channel or using a MAC-CE. The dynamic indication may be regarded as useful to promptly switch among distinct beam angular direction adjustment configurations. The dynamic indication may also be regarded as useful to indicate a one-time shift or other adjustments to transmit/receive beam directions.

Upon receipt of the beam angular direction adjustment, the UE 110 may use the beam angular direction adjustment to determine an initial guess for a receive beam direction as the receive beam direction evolves over time when one or both of the UE 110 and the NT-TRP 172 are moving. The UE 110 can further use the beam angular direction adjustment to find a more accurate estimate of the receive beam direction by exploiting local measurements. These measurements, in turn, may be used, by the UE 110, to detect a misalignment.

In a situation wherein at least one of the NT-TRP 172 and the UE 110 are moving, the angle of departure (AoD) of a signal at the transmitter side and the angle of arrival (AoA) of the same signal at the receiver side are both expected to change with time.

It may be observed that, when the transmitter and/or receiver are moving relative to each other but with a fixed heading with respect to each respective coordinate system, the (absolute) changes in an azimuth angle and an elevation angle for the AoD at the transmitter side have an equivalence to the (absolute) changes in the azimuth angle and the elevation angle for the AoA at the receiver side. This equivalence may established, in general, in view of the NT-TRP 172 measuring the azimuth angle and the elevation angle of transmitted/received beams with respect to an arbitrary horizontal coordinate system and in view of the UE 110 measuring the azimuth angle and the elevation angle of received/transmitted beams with respect to the same horizontal coordinate system.

The changes may be in the same direction or in an opposite direction, with dependence upon whether there is a line-of-sight (LOS) transmission path for each of the azimuth angle and the elevation angle. For a change, Δφ, in an azimuth angle, φ, of a LOS transmission path, the change may be shown to be in the same direction, that is, Δφₜ=Δφᵣ. In contrast, for a change, Δφ, in an azimuth angle of a non-line-of-sight (NLOS) transmission path with one reflection, the change may be shown to be in an opposite direction, that is, Δφₜ=−Δφᵣ. For a change, Δθ, in an elevation angle, θ, in a LOS transmission path, the change may be shown to be in an opposite direction, that is, Δθₜ=−Δθᵣ. For a change, Δθ, in an elevation angle of a NLOS transmission path with one reflection, the change may be shown to be in the same direction, that is, Δθₜ=Δθᵣ.

For NT-TRPs 172, there is usually a dominant LOS transmission path to a given UE 110. Accordingly, for the sake of illustration in the present application, attention may be restricted to the azimuth angle for a LOS transmission path. It should be clear, however, that aspects of the present application may be applicable to every transmission path.

The changes in AoA or AoD may, therefore, be estimated at one of a transmitter or a receiver when a trend of changes is known for the other of the transmitter or the receiver. In particular, a new AoA may be estimated at the UE 110 when a trend of changes for the AoD is indicated, by the NT-TRP 172, to the UE 110.

The trend of changes for the AoD may be represented as the beam angular direction adjustment. In practice, however, it may be shown that using the beam angular direction adjustment, the UE 110 may not perfectly predict actual changes in the receive beam direction.

The trend of changes for the AoD may be represented as a change in a transmit beam direction, ϕₜ. Let Δϕₜ=ϕₜ(t₂)−ϕₜ(t₁) denote the change in the transmit beam direction, ϕₜ. The NT-TRP 172 may indicate the change, Δϕₜ, to the UE 110, based on transmit beam direction shifting over a time interval, (t₁, t₂). Based on observations discussed hereinbefore, the UE 110 may adjust a receive beam direction, (ϕᵣ, by Δϕᵣ=Δϕₜ. Actual changes in AoD or AoA, which may be determined based on an actual transmission path, however, could be different than the changes that are expected on the basis of predicted changes in the transmit beam direction.

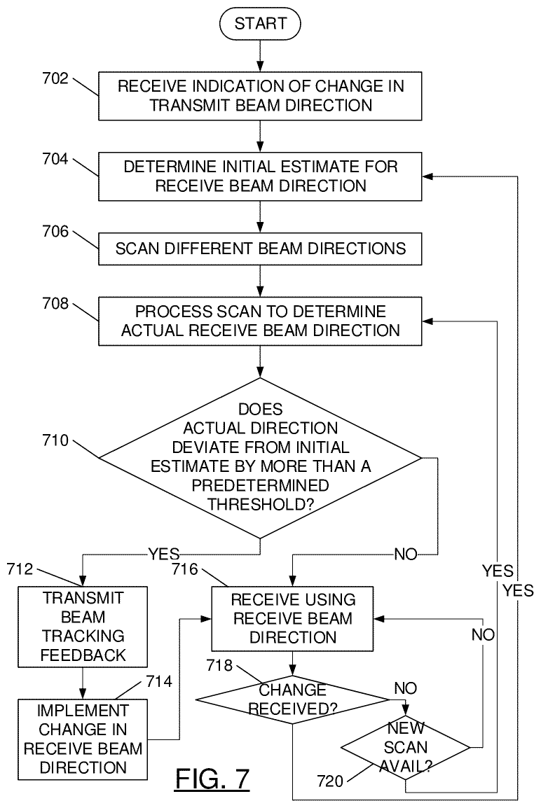

FIG. 7 illustrates example steps in a method of feeding back beam tracking information.

In an actual implementation, the indicated change, Δϕₜ, in the transmit beam direction may be used to find an initial estimate, \hat{ϕ}ᵣ, for the receive beam direction. That is, the UE 110 receives (step 702) the indicated change, Δϕₜ, and determines (step 704) the initial estimate, \hat{ϕ}r, by adjusting the current receive beam direction, ϕᵣ, by Δϕᵣ=Δϕₜ. Assuming that the discrepancy between the initial estimate, \hat{ϕ}ᵣ, and an actual AoA, ϕᵣ, is within a beamwidth of the UE 110, the UE 110 may use the initial estimate, \hat{ϕ}ᵣ, as the receive beam direction. The UE 110 may then scan (step 706) a range of slightly different beam directions (around the initial estimate, \hat{ϕ}ᵣ), by recording measurements of various reference signals that are transmitted, by the NT-TRP 172 to the UE 110, along with data or information on control channels.

The UE 110 may then process (step 708) the recorded measurements. The result of the processing (step 708) may be that the UE 110 determines an actual receive beam direction, ϕᵣ. The actual receive beam direction, ϕᵣ, may be defined, for example, as the receive beam direction that results in a maximum received power.

In this sense, the indicated change, Δϕₜ, in the transmit beam direction may be understood to facilitate beam tracking at the UE 110 by providing the UE 110 with a basis for determining (step 704) the initial estimate, \hat{ϕ}ᵣ, for the receive beam direction. The UE 110 may then perform “beam refinement” by scanning (step 706) a few potential directions around the initial estimate, \hat{ϕ}ᵣ, to, thereby, determine (step 708) the actual receive beam direction, ϕᵣ.

The UE 110 may then determine (step 710) whether the actual receive beam direction, ϕᵣ, deviates from the initial estimate, \hat{ϕ}ᵣ, by more than a predetermined threshold. If the actual receive beam direction, ϕᵣ, is determined (step 710) to deviate from the initial estimate, \hat{ϕ}ᵣ, by more than the predetermined threshold, a beam tracking feedback procedure may be triggered. As part of the beam tracking feedback procedure, the UE 110 transmits (step 712), to the NT-TRP 172, an indication of a change in the transmit beam direction that the NT-TRP 172 is to implement.

The UE 110 may use a parameter, δ, to indicate an amount of change to be applied to both the transmit beam direction, at the NT-TRP 172, and the receive beam direction, at the UE 110, to align the transmit/receive beam pair. If a value for the parameter, δ, is configured by the NT-TRP 172, then the UE 110 may simply transmit (step 712) a single bit of feedback to the NT-TRP 172. In a case wherein a value for the parameter, δ, is configured by the UE 110, the UE 110 transmits (step 712), to the NT-TRP 172, an indication of a value for the parameter, δ. The UE 110 may indicate a value for the parameter, δ, using only a few bits, because the UE 110 is only indicating a relative shift in the transmit beam direction.

Whether performed by the NT-TRP 172 or the UE 110, selection of the parameter, δ, may take into account a tradeoff between maximizing a likelihood of detecting a misalignment before a beam failure happens and minimizing a number of feedback messages transmitted, to the NT-TRP 172, from the UE 110.

Subsequent to transmitting (step 712) beam tracking feedback to the NT-TRP 172, the UE 110 may implement (step 714) an appropriate change in the receive beam direction and proceed to receive (step 716) communication from the NT-TRP 172 using the new receive beam direction. Additionally, upon determining (step 710) that the actual receive beam direction, ϕᵣ, does not deviate from the initial estimate, \hat{ϕ}ᵣ, by more than the predetermined threshold, the UE 110 may proceed to receive (step 716) communication from the NT-TRP 172 using the actual receive beam direction. The receiving (step 716) the communication may include the UE 110 tracking the receive beam over a certain time interval, given a certain beam angular direction adjustment, until a deviation is detected. Upon detecting a deviation (not specifically shown), the UE 110 may autonomously (i.e., without receiving an indication, from the NT-TRP 172, of a change in receive beam direction) adjust the receive beam direction. Upon determining (step 718) that an indication of a change in the receive beam direction has been received, the UE 110 may make adjustments to the receive beam direction, starting with using the indication as a basis for determining (step 704) an initial estimate, \hat{ϕ}ᵣ, for the new receive beam direction. Upon determining (step 718) that an indication of a change in the receive beam direction has not been received, the UE 110 may determine (step 720) whether a new measurement/scanning result is available. Upon determining (step 720) that a new measurement/scanning result is available, the UE 110 may proceed to process (step 708) the new measurement/scanning result. Upon determining (step 720) that a new measurement/scanning result is not available, the UE 110 may continue to use the beam direction currently in use.

By indicating the change, Δϕₜ, in the transmit beam direction, the NT-TRP 172 may be seen to assist the UE 110 to adaptively adjust the receive beam direction. Conveniently, the UE 110 may accomplish the adjusting without carrying out beam sweeping in a wide range of directions. Moreover, by performing local measurements in a range of slightly different directions around the transmit beam direction, the UE 110 may be able to find an accurate estimate, \hat{ϕ}ᵣ, of an actual AoA while maintaining a low complexity. Besides enhancing the beam alignment, the UE 110 may be empowered to detect a misalignment in advance before a beam failure happens.

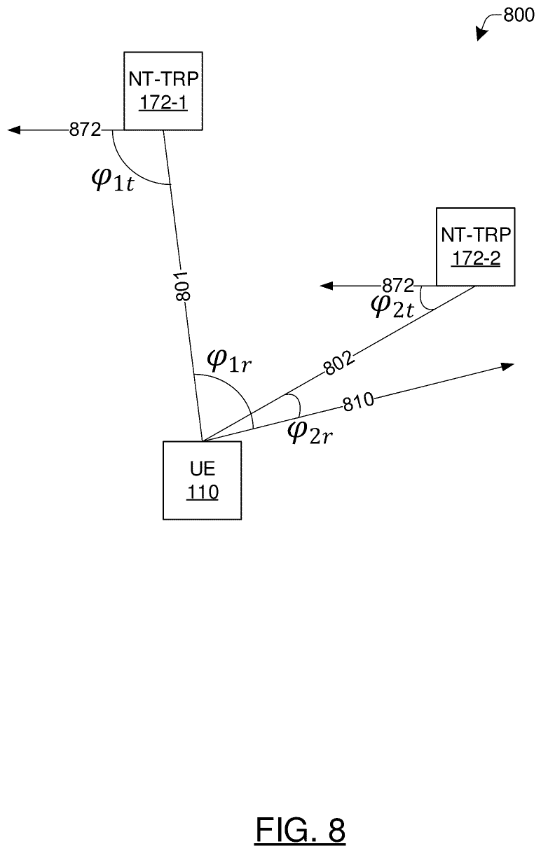

FIG. 8 illustrates a portion 800 of a network. The portion 800 includes a first NT-TRP 172-1, a second NT-TRP 172-2 and a UE 110. The first NT-TRP 172-1 is associated with a TRP horizontal coordinate system 872. The second NT-TRP 172-2 is also associated with the TRP horizontal coordinate system 872. The UE 110 is associated with a UE horizontal coordinate system 810.

FIG. 8 also illustrates a first direction 801 for a beam pair over which communication may occur between the first NT-TRP 172-1 and the UE 110. An example first transmission azimuth angle, φ₁ₜ, is illustrated between the first direction 801 and the TRP horizontal coordinate system 872. An example first reception azimuth angle, φ₁ᵣ, is illustrated between the first direction 801 and the UE horizontal coordinate system 810.

FIG. 8 further illustrates a second direction 802 for a beam pair over which communication may occur between the second NT-TRP 172-2 and the UE 110. An example second transmission azimuth angle, φ₂ₜ, is illustrated between the second direction 802 and the TRP horizontal coordinate system 872. An example second reception azimuth angle, φ₂ᵣ, is illustrated between the second direction 802 and the UE horizontal coordinate system 810.

In aspects of the present application, the transmit/receive beam pair direction 801 for a connection between the UE 110 and the first NT-TRP 172-1 may be used to facilitate beam establishment, refinement and tracking for a connection between the UE 110 and the second NT-TRP 172-2.

A transmission azimuth difference, Ape, may be defined between the first transmission azimuth angle, φ₁ₜ, and the second transmission azimuth angle, φ₂ₜ, such that Δφₜ=φ₂ₜ−φ₁ₜ. Similarly, a reception azimuth difference, Δφᵣ, may be defined between the first reception azimuth angle, φ₁ᵣ, and the second reception azimuth angle, φ₂ᵣ, such that Δφᵣ=φ₂ᵣ−φ₁ᵣ.

The observation can be established that the absolute value of the transmission azimuth difference, Δφₜ, is equal to the absolute value of the reception azimuth difference, Δφ₁ᵣ, at the same instant of time, that is, |Δφᵣ|=|Δφₜ|.

It follows that a transmission elevation difference, Δθₜ, may be defined between the first transmission elevation angle, θ₁ₜ, and the second transmission elevation angle, θ₂ₜ, such that Δθₜ=θ₂ₜ−θ₁ₜ. Similarly, a reception elevation difference, Δθᵣ, may be defined between the first reception elevation angle, θ₁ᵣ, and the second reception elevation angle, θ₂ᵣ, such that Δθᵣ=θ₂ᵣ−θ₁ᵣ.

The observation can be established that the absolute value of the transmission elevation difference, Δθₜ, is equal to the absolute value of the reception elevation difference, Δθᵣ, at the same instant of time, that is, |Δθᵣ|==|Δθₜ|.

The same observation may be established in general, in view of each NT-TRP 172 among a plurality of NT-TRPs 172 measuring the azimuth angle and the elevation angle of transmitted/received beams with respect to a predetermined and arbitrary, yet consistent, horizontal coordinate system and in view of each UE 110 among a plurality of UEs 110 measuring the azimuth angle and the elevation angle of received/transmitted beams with respect to the same horizontal coordinate system. Based on this observation, either the AoD or the AoA may be determined for a new connection to the second NT-TRP 172-2 if either of the AoD or the AoA is known with respect to an existing connection to the first NT-TRP 172-1.

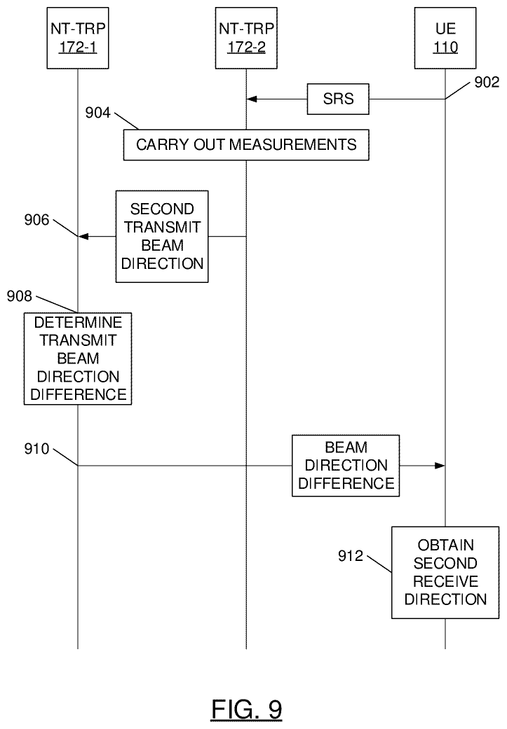

In view of the example illustrated in FIG. 8 and a signal flow diagram illustrated in FIG. 9, consider a scenario wherein the UE 110 is initially connected to the first NT-TRP 172-1. The second NT-TRP 172-2 may carry out (step 904) some measurements based on a Sounding Reference Signal (SRS) transmitted (step 902) by the UE 110 so as to estimate a preferred second transmit beam direction, ϕ₂ₜ, for future transmissions to the UE 110. The first NT-TRP 172-1 may receive (step 906), from the second NT-TRP 172-2, an indication of the estimate of the preferred second transmit beam direction, ϕ₂ₜ. The first NT-TRP 172-1 may use a first transmit beam direction, ϕ₁ₜ, in combination with the preferred second transmit beam direction, ϕ₂ₜ, to determine (step 908) a transmit beam direction difference, Δϕₜ. The first NT-TRP 172-1 may then indicate (step 910), to the UE 110, a receive beam direction difference, Δϕᵣ, which is the same as the transmit beam direction difference, Δϕₜ. The receive beam direction difference, Δϕᵣ, in combination with a first receive beam direction (a first AoA), ϕ₁ₜ, allows the UE 110 to obtain (step 912) an estimate of a second receive beam direction, ϕ₂ᵣ, for communications that are to be received, at the UE 110, from the second NT-TRP 172-2. In particular, the UE 110 may use the receive beam direction difference (relative change in AoA), Δϕᵣ, in combination with the first AoA, ϕ₁ᵣ, for the receive beam direction 801 of the first NT-TRP 172-1, to obtain the estimate of the second receive beam direction, ϕ₂ᵣ=Δϕᵣ−ϕ₁ᵣ. In this way, the UE 110 is given an ability to initiate a connection to the second NT-TRP 172-2 without performing beam sweeping and measurement. Based on the relative change in AoA, Δϕᵣ, indicated by the first NT-TRP 172-1, the UE 110 may be able to determine whether there is sufficient reason to switch to a different antenna panel for communicating with the second NT-TRP 172-2. In aspects of the present application, the second NT-TRP 172-2 may determine (step 908), and indicate (step 910) to the UE 110, the receive beam direction difference, Δϕᵣ.

Aspects of the present application relate to using the observation discussed in relation to FIG. 8 for the sake of beam tracking in a connected mode. In particular, consider a scenario where the UE 110 in FIG. 8 is connected both to the first NT-TRP 172-1 and to the second NT-TRP 172-2. The first NT-TRP 172-1 may be assumed to be implementing an accurate beam tracking algorithm. For a connection between the UE 110 and the second NT-TRP 172-2, the second NT-TRP 172-2 may implement a beam tracking algorithm to keep track of a best angle, ϕ₂ₜ, for the transmit beam direction 802. The beam tracking algorithm implemented at the second NT-TRP 172-2 may involve tracking changes, Δϕ₂ᵣ, in the AoA at the UE 110, of communication from the second NT-TRP 172-2 compared to changes, Δϕ₁ᵣ, in the AoA at the UE 110, of communication from the first NT-TRP 172-1.

In general, and based on the observation discussed in relation to FIG. 8, beam tracking in the presence of multiple NT-TRPs 172 may be facilitated by determining a transmit or receive beam direction only at an appropriate one of the transmitter or the receiver.

Aspects of the present application relate to beam establishment and tracking when the same NT-TRP is employing multiple beams for communication with a UE 110, possibly through combination of LOS and NLOS transmission paths. The absolute values of the differences in a plurality of AoDs, measured at the NT-TRP 172 for a plurality of beams may be shown to have an equality to the differences in a corresponding plurality of AoAs that are measured at the UE 110. Based on this equality, the UE 110 may manage receive beam directions for additional beams by noting an AoA difference of a direction for a new beam compared to an AoA difference of a direction for an established beam.

Conveniently, the foregoing illustrated that, in the presence of multiple TRPs, information related to the transmit/receive beam direction of a first established/aligned beam may be used to help align other beams. The use of this information may be shown to reduce signaling and overhead that would, otherwise, be used for beam establishment, beam alignment refinement and beam tracking.

Aspects of the present application relate to beam probing in incremental directions. In particular, consider a scenario wherein a Tracking Reference Signal (TRS) is initially QCL with an SSB. Furthermore, the TRS is configured to gradually shift. It is proposed, herein, to configure the NT-TRP 172 to transmit, to the UE 110 using the DCI channel or the MAC-CE, beam angular direction adjustment information for the TRS along with a System Information Block (SIB). The beam angular direction adjustment information for the TRS may be configured to cause beam direction changes for the TRS to occur relatively more frequently for UEs 110 with relatively higher mobility and for NT-TRPs 172 with relatively higher mobility. Accordingly, the UE 110 may be expected to receive the TRS with a different receive power depending on an array factor and an alignment of the beam-formed TRS transmitted by the NT-TRP 172. By carrying out beam measurements in incremental directions, the UE 110 may determine a preferred receive beam direction, as well as an expected 3 dB beam-width coverage duration.

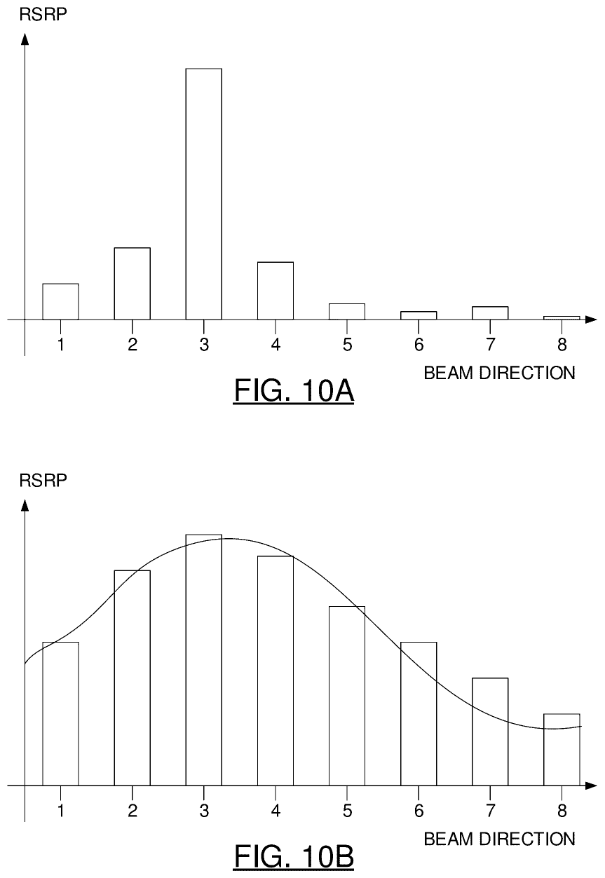

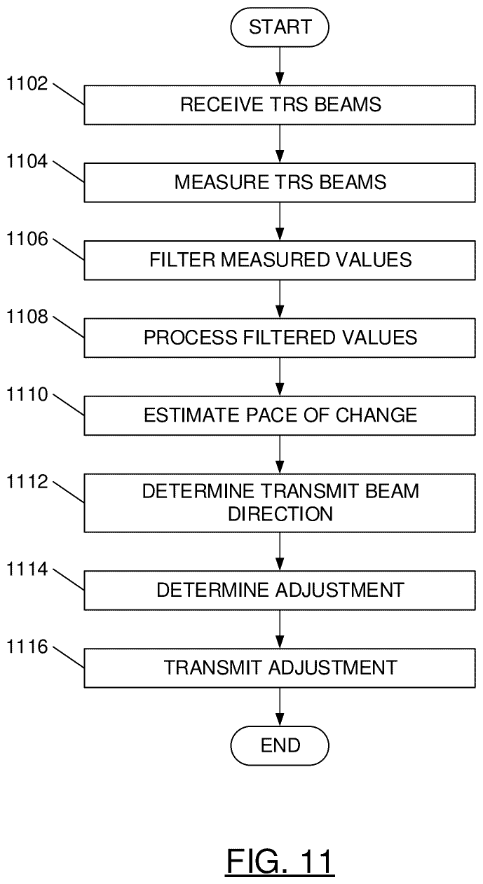

FIG. 11 illustrates example steps in a method of using TRS, received at the UE 110, to facilitate agile beam tracking at the NT-TRP 172. The UE 110 may receive (step 1102) each of the TRS beams and measure (step 1104) an RSRP for each of the TRS beams, transmitted by the NT-TRP 172 with distinct directions. The distinct directions may be predicted, by the UE 110, on the basis of an initial beam direction associated with receipt of the SSB in combination with the beam angular direction adjustment information for the TRS. Indeed, the initial beam direction may be gradually shifted and each shifted beam direction may be associated with a TRS transmitted at a distinct time instant. FIG. 10A illustrates a histogram showing measured TRS RSRP values on a vertical axis and TRS beam directions on a horizontal axis.

The UE 110 may filter (step 1106) the measured TRS RSRP values, thereby leading to filtered TRS RSRP values. FIG. 10B illustrates a histogram showing filtered TRS RSRP values on a vertical axis and beam directions on a horizontal axis. The UE 110 may process (step 1108) the filtered TRS RSRP values to, thereby, extract some information from the TRS RSRP measured values. The processing may, for example, relate to applying regression to the filtered TRS RSRP values. FIG. 10B illustrates an example regression curve plotted on the illustrated histogram. Because each of the beam directions are received at a distinct time, the processing may allow the UE 110 to use the result of the processing to estimate (step 1110) a pace of the changes in a preferred receive beam direction. Based on the filtered RSRP values and based on the estimated pace of changes in the preferred beam direction, the UE 110 may determine (step 1112) a preferred transmit beam direction to be implemented by the NT-TRP 172. The UE 110 may use an awareness of a current transmit beam direction to determine (step 1114) an adjustment (e.g., a shift from the current transmit beam direction to a shifted transmit beam direction) for the transmit beam direction. The UE 110 may then transmit (step 1116), to the NT-TRP 172, an indication of the adjustment.

It is worth noting that TRSs are common reference signals and that TRSs have a rather wide beam width (e.g., like SSBs) that can be used by different UEs 110 for the sake of synchronization and beam refinement. The transmission of a TRS is in contrast to the transmission of UE-specific CSI-RSs with narrow beam-width in various directions to find the best transmit beam direction for each UE 110. Indeed, by gradually shifting the beam direction of the already existing TRSs, the transmit beam direction may be refined for each UE 110 without UE-specific CSI-RS transmissions, thus reducing overhead for facilitating beam tracking and refinement at the UE 110 and at the NT-TRP 172.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method at a first device, the method comprising:
determining a first transmit beam direction;
transmitting a first transmission to a second device, the first transmission using the first transmit beam direction;
determining a second transmit beam direction based on the first transmit beam direction and a beam angular direction adjustment; and
transmitting a second transmission, subsequent to the first transmission, to the second device, the second transmission using the second transmit beam direction,
wherein the beam angular direction adjustment indicates one or more changes, over a time interval, in transmit beam directions.

2. The method of claim 1, wherein the beam angular direction adjustment indicates the one or more changes with respect to a fixed coordinate system centered at a location for the first device.

3. The method of claim 1, wherein the beam angular direction adjustment indicates the changes in two orthogonal base directions with respect to a reference beam.

4. The method of claim 3, wherein the two orthogonal base directions comprise at least one of an elevation direction or an azimuth direction.

5. The method of claim 1, wherein the beam angular direction adjustment includes compensation for at least one of angular rotations of first device mobility of the first device.

6. The method of claim 1, wherein the beam angular direction adjustment is associated with the second device.

7. The method of claim 1, further comprising:
transmitting, to the second device, an indication of the beam angular direction adjustment.

8. The method of claim 1, further comprising:
transmitting, to the second device, an indication of a shift from the first transmit beam direction to the second transmit beam direction.

9. The method of claim 7, wherein the transmitting the indication comprises:
using radio resource control (RRC) signaling or dynamic indication.

10. A method at a first device, the method comprising:
receiving first communication from a second device, the receiving the first communication using a first receive beam direction;
receiving, from the second device, an indication of a beam angular direction adjustment for the first communication, wherein the beam angular direction adjustment indicates one or more changes, over a time interval, in transmit beam directions;
detecting, based on the beam angular direction adjustment, a beam misalignment;
shifting the first receive beam direction according to the beam angular direction adjustment to, thereby, obtain a second receive beam direction; and
receiving second communication from the second device, the receiving the second communication using the second receive beam direction.

11. The method of claim 10, wherein the shifting comprises:
adjusting the first receive beam direction.

12. The method of claim 10, wherein the shifting comprises:
switching from a first plurality of antenna panels to a second plurality of antenna panels.

13. The method of claim 10, further comprising:
using the beam angular direction adjustment to obtain an initial guess receive beam direction.

14. The method of claim 13, further comprising:
refining the initial guess receive beam direction to obtain the second receive beam direction.

15. A first device comprising:
at least one processor coupled with a non-transitory computer-readable storage medium storing instructions, wherein when the instructions executed by the at least one processor, cause the first device to perform operations including:
receiving first communication from a second device, the receiving the first communication using a first receive beam direction;
receiving, from the second device, an indication of a beam angular direction adjustment for the first communication, wherein the beam angular direction adjustment indicates one or more changes, over a time interval, in transmit beam directions;
detecting, based on the beam angular direction adjustment, a beam misalignment;
shifting the first receive beam direction according to the beam angular direction adjustment to, thereby, obtain a second receive beam direction; and
receiving second communication from the second device, the receiving the second communication using the second receive beam direction.

16. The first device of claim 15, wherein the shifting comprises:
adjusting the first receive beam direction.

17. The first device of claim 15, wherein the shifting comprises:
switching from a first plurality of antenna panels to a second plurality of antenna panels.

18. The first device of claim 15, the operations further comprising:
using the beam angular direction adjustment to obtain an initial guess receive beam direction.

19. The first device of claim 18, the operations further comprising:
refining the initial guess receive beam direction to obtain the second receive beam direction.

20. The first device of claim 15, the operations further comprising:
determining, based on the beam angular direction adjustment, an expected change in a transmitted beam direction;
determining, based on the expected change in the transmitted beam direction, an expected angle of arrival; and
obtaining, based on measurements, a measured angle of arrival,
wherein the detecting the beam misalignment includes comparing the expected angle of arrival to the measured angle of arrival.
